(19) United States
(12) Patent Application Publication
(10) Pub. No.: US 2009/0104982 A1
(43) Pub. Date: Apr. 23, 2009

(54) Game System

(75) Inventor: Kazuo Okada, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE GAMING AMERICA, INC., Las Vegas, NV (US)

(21) Appl. No.: 12/034,869

(22) Filed: Feb. 21, 2008

Related U.S. Application Data
(60) Provisional application No. 60/981,008, filed on Oct. 18, 2007.

(51) Int. Cl. A63F 9/24; A63F 13/12

(52) U.S. Cl. 463/27; 463/31; 463/40

(57) ABSTRACT

A game system includes plural gaming machine and a common display. Also, the game system has a processor, the processor making image effects of a display of a predetermined gaming machine and image effects of a common display cooperate.

### CROSS-REFERENCE TO RELATED APPLICATIONS

This application is based upon and claims a priority from the U.S. Provisional Patent Application No. 60/981,008 filed on Oct. 18, 2007, the entire contents thereof are incorporated herein by reference for all purposes.

### BACKGROUND

1. Field

Game systems related to one or more aspects of present invention have plural gaming machines and plural displays, particularly, in the game systems, to attract players, cooperative image effects are made on a predetermined display and a common display.

2. Description of Related Art

To enhance entertainment aspects, there are gaming machines which make image effects when a predetermined condition is met. Also, to attract players, a gaming machine which has new feature is anticipated.

### SUMMARY

A game system related to one or more aspects of present invention has plural gaming machines and a common display. Also, the game system includes a processor, the processor making image effects of a display of a predetermined gaming machine and image effects of the common display cooperate. Accordingly, entertainment aspects are enhanced, and it allows attracting the players.

Also, a game system related to one or more aspects of present invention has plural gaming machines and a common display. Also, the game system includes a processor, the processor identifying a gaming machine in which a predetermined condition is met among the plural gaming machines, and making image effects of a display of the identified gaming machine and image effects of the common display cooperate. Accordingly, entertainment aspects are enhanced, and it allows attracting the players.

Also, a game system of one or more aspects of present invention has plural gaming machines and a common display. Also, each of the plural gaming machines has a display and controller. The controller performs variably display of symbols on the display and determines whether or not a predetermined condition is met based on the displayed symbols. Also, the game system has a processor, the processor identifying a gaming machine in which the predetermined condition is met among the plural gaming machines, and making image effects of a display of the identified gaming machine and image effects of the common display cooperate. Accordingly, entertainment aspects are enhanced, and it allows attracting the players.

Also, a game system related to one or more aspects of present invention has plural gaming machines and a common display. Also, each of the plural gaming machines has a display and a controller. The controller performs spinning and stopping of video reels and determines whether or not a predetermined condition is met based on the displayed symbols. Also, the game system has a processor, the processor identifying a gaming machine in which the predetermined condition is met among the plural gaming machines, and making image effects of a display of the identified gaming machine and image effects of the common display cooperate. Accordingly, entertainment aspects are enhanced, and it allows attracting the players.

One or more of the above aspects of the invention will be more fully described in the following detailed description when read in connection with the accompanying drawings. It is to be expressly understood, however, that the drawings are for purpose of illustration only and not intended as a definition of the limits of the invention.

### BRIEF DESCRIPTION OF THE DRAWINGS

FIG. 1 is a view showing an example of image effects of a main display, an upper display, and a lower display in one embodiment of the present invention.

FIG. 2 is a view showing a construction of a game system in one embodiment of the present invention.

FIG. 3 is a view showing an outline of a slot machine in one embodiment of the present invention.

FIG. 4 is a view showing a control system of the slot machine in one embodiment of the present invention.

FIG. 5 is a view showing a control system of a server in one embodiment of the present invention.

FIG. 6 is a view showing a positional relationship between the slot machines and the main display in one embodiment of the present invention.

FIG. 7 is a flowchart of a main control process in one embodiment of the present invention.

FIG. 8 is a flowchart of a main game process in one embodiment of the present invention.

FIG. 9 is a flowchart of a sever base process in one embodiment of the present invention.

FIG. 10 is an example image display of the main display, the upper display, and the lower display in one embodiment of the present invention in a base game.

FIG. 11 is a view showing a correspondence relationship between jackpots and fish in one embodiment of the present invention.

FIG. 12 a view showing an example of image effects of the main display, the upper display, and the lower display in one embodiment of the present invention.

FIG. 13 a view showing an example of image effects of the main display, the upper display, and the lower display in one embodiment of the present invention.

FIG. 14 a view showing an example of image effects of the main display, the upper display, and the lower display in one embodiment of the present invention.

FIG. 15 is a flowchart of a main game process in one embodiment of the present invention.

FIG. 16 is a flowchart of a sever base process in one embodiment of the present invention.

FIG. 17 a view showing an example of image effects of the main display, the upper display, and the lower display in one embodiment of the present invention.

FIG. 18 a view showing an example of image effects of the main display, the upper display, and the lower display in one embodiment of the present invention.

FIG. 19 a view showing an example of image effects of the main display, the upper display, and the lower display in one embodiment of the present invention.

FIG. 20 is a flowchart of a main game process in one embodiment of the present invention.

FIG. 21 is a flowchart of a sever base process in one embodiment of the present invention.

FIG. 22 a view showing an example of image effects of a main display, an upper display, and a lower display in one embodiment of the present invention.

FIG. 23 a view showing an example of image effects of a main display, an upper display, and a lower display in one embodiment of the present invention.

### DETAILED DESCRIPTION

The various aspects summarized previously may be embodied in various forms. The following description shows by way of illustration of various combinations and configurations in which the aspects may be practiced. It is understood that the described aspects and/or embodiments are merely examples, and that other aspects and/or embodiments may be utilized and structural and functional modifications may be made, without departing from the scope of the present disclosure.

It is noted that various connections are set forth between items in the following description. It is noted that these connections in general and, unless specified otherwise, may be direct or indirect and that this specification is not intended to be limiting in this respect.

A gaming machine, a server, and a game system according to one or more aspects of the invention will be described in detail with reference to the drawings based on an embodiment embodying one or more aspects of the invention. However, it is appreciated that one or more aspects of the present invention may be embodied in distributable (via CD and the like) or downloadable software games, console games, and the like. In this regard, the slot machine may be a virtual slot machine that is displayed on a multi-purpose computer and/or dedicated kiosk. Aspects of the invention are described by way of hardware elements. However, it is appreciated that these elements may also be software modules that are executable in a computer. The software modules may be stored on a computer readable medium, including but not limited to a USB drive, CD, DVD, computer-readable memory, tape, diskette, floppy disk, and the like. For instance, aspects of the invention may be embodied in a JAVA-based application or the like that runs in a processor or processors. Further, the terms “CPU”, “processor”, and “controller” are inclusive by nature, including at least one of hardware, software, or firmware. These terms may include a portion of a processing unit in a computer (for instance, in multiple core processing units), multiple cores, a functional processor (as running virtually on at least one of processor or server, which may be local or remote). Further, in network-based gaming systems, the processor may include only a local processor, only a remote server, or a combination of a local processor and a remote server.

It is contemplated that one or more aspects of the invention may be implemented as computer executable instructions on a computer readable medium such as a non-volatile memory, a magnetic or optical disc. Further, one or more aspects of the invention may be implemented with a carrier signal in the form of, for instance, an audio-frequency, radio-frequency, or optical carrier wave.

### First Embodiment

Hereinafter, a game system related to present invention will be described in detail with reference to the drawings based on a first embodiment embodying a system 3. And, a gaming machine related to the present invention will be described in detail with reference to the drawings based on the first embodiment embodying a slot machine 1.

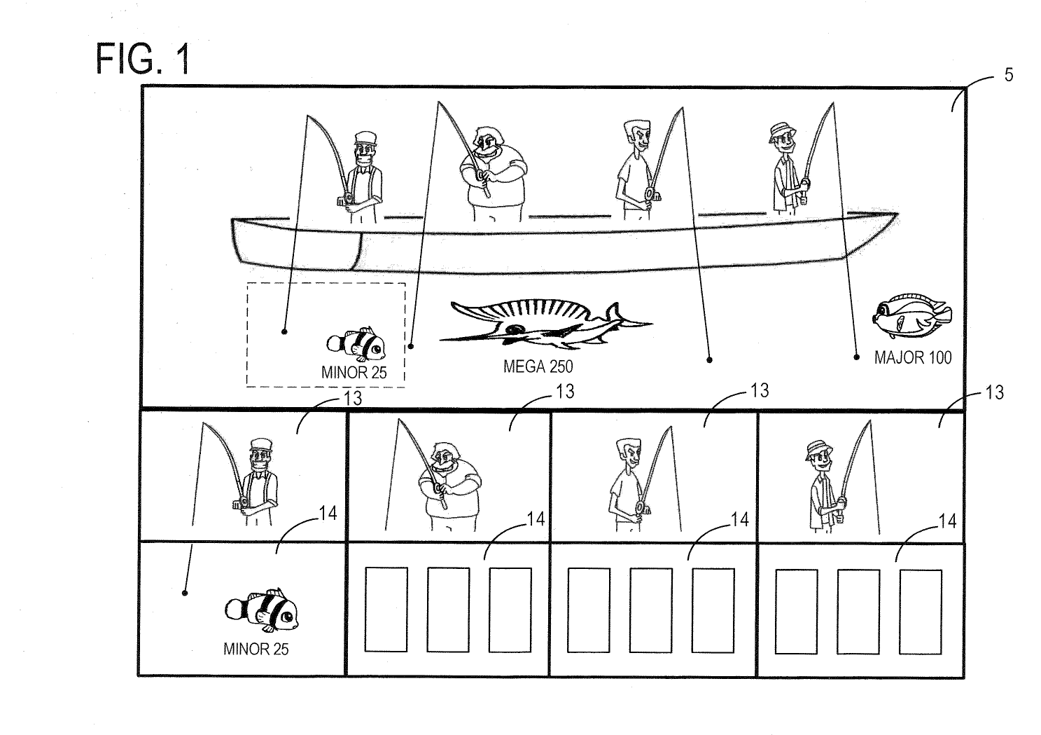

The system 3 related to the embodiment is made up of plural slot machine 1 and a server 2. Also, a main display 5 is arranged on top of the plural slot machines 1. And, cooperative image effects are made on among an upper display 13 and a lower display 14 of a predetermined slot machine 1 and the main display 5 (see FIG. 1).

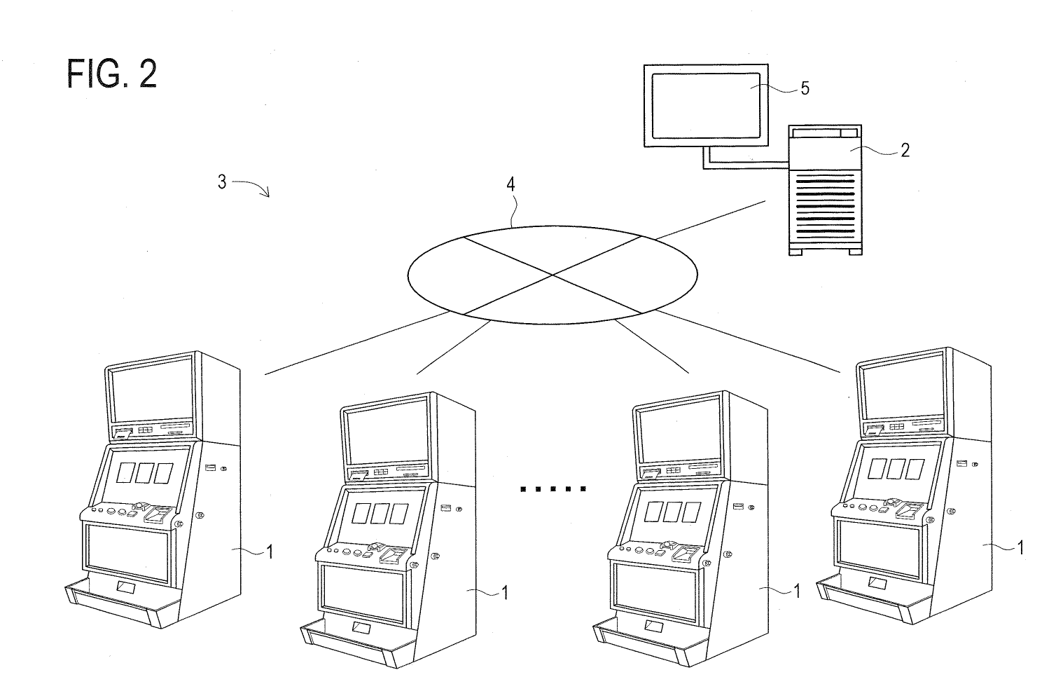

At first, a schematic construction of the system 3 will be described. FIG. 2 is a schematic construction diagram of the system 3 related to the embodiment.

As shown in FIG. 2, the system 3 related to the embodiment includes plural slot machines 1 and the server 2. The plural slot machines 1 and the server 2 are arranged inside a gaming hall. Each of the slot machines 1 and the server 2 are interconnected to communicate via a network 4.

The network 4 is made up of communication line which enables two-way communication. And, the slot machines 1 and the sever 2 send and receive various information related to games via the network 4. For example, when a bet operation is made in the slot machine 1, bet information is sent from the slot machine 1 to the server 2. Here, the bet information includes bet amount and information to identify a slot machine 1 which is bet.

And, if the slot machine 1 wins progressive bonus, winning information is sent from the slot machine 1 to the server 2. Here, the winning information includes information to identify the progressive bonus which is won and information to identify the slot machine 1 which is won. And, jackpot amount, corresponding to the progressive bonus which is won, is sent from the server 2 to the slot machine 1 which is won.

Further, if a bonus trigger of the slot machine is realized, a trigger realizing information is sent from the slot machine 1 to the server 2. Here, the trigger realizing information includes information indicating that the bonus trigger was realized. Also, information to identify the slot machine 1 in which the bonus trigger was realized can be included.

Also, winning notification information indicating the progressive bonus is won is sent from the server 2 to the slot machine 1 in which the progressive bonus is won. Here, the winning notification information also includes information to identify a type of won progressive bonus and jackpot amount of jackpot corresponding to the won progressive bonus.

The server 2 has the main display 5. The main display 5 is arranged where all players who play each of the slot machines 1 can look. The server 2 has storage areas for three different jackpots (“MEGA jackpot”, “MAJOR jackpot”, and “MINOR jackpot”). Three fish to indirectly notify jackpot amount of each of the jackpots are displayed on the main display 5 (see FIG. 1). Also, anglers corresponding to each of the slot machines are displayed. Further, plural anglers and a boat on which the plural anglers ride are displayed. Here, display contents image of FIG. 1 is only one example.

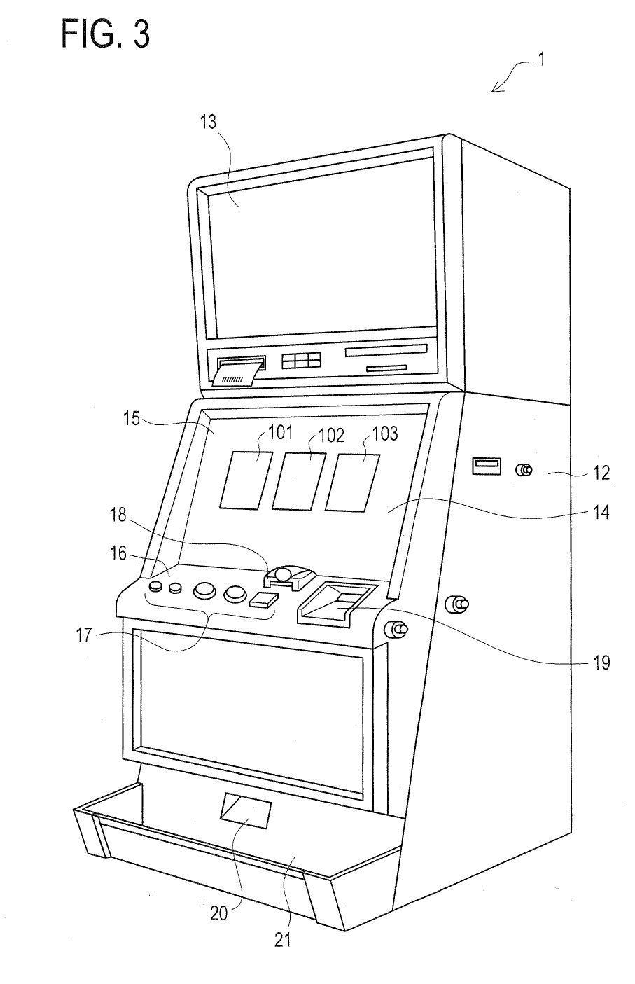

FIG. 3 shows an outline view of the slot machine 1. Each of the slot machines 1 has identification number. This identification number is stored in a predetermined memory medium embedded in the slot machine 1, for example. Also, the server 2 can identify connected slot machines 1 using this identification numbers.

As shown in FIG. 3, the slot machine 1 has a cabinet 12. The slot machines 1 have the upper display 13 and the lower display 14 in front of the cabinet 2 to display various game information. The upper display 13 is arranged on upper side of the cabinet 2. The lower display 14 is arranged on lower side of the cabinet 2.

The upper display 13 is made up of liquid crystal display, for example. The lower display 14 is made up of the liquid crystal display, for example. The lower display 14 has three reel display portions 101 to 103, for example. The base game is executed using the reel display portions 101 to 103. In the base game, variably display and stopped display of symbol rows is performed in each of the reel display portions. Here, the number of symbol rows is variable.

A touch panel 15 is arranged in front of the lower display 14. A player can input various instructions by operating the touch panel 15.

The upper display 13 and the lower display 14 are made up of the liquid crystal display as mentioned, however, the embodiment is not so limited. That is, CRT displays, plasma displays, LED displays, or other known display devices can be used.

And, the slot machine 1 of the embodiment can be hybrid type slot machine made up of mechanical reels and transparent liquid crystal display device arranged in front of the mechanical reels. In this case, symbols displayed on the mechanical reels are visible perceived via the transparent liquid crystal display device. Also, it is preferable that display windows whose number is the same as the number of the mechanical reels is arranged on the transparent liquid crystal display device and it is constructed so that symbols displayed on the mechanical reels are visible perceived via the window displays. Here, in following explanation, slot machines using video reels are mainly described, however, naturally, the present invention is can be applied to slot machines using mechanical reels within applicable limits.

An operation table 16 formed by projecting to proximal side is provided at the bottom of the lower display 14. Various operation buttons 17, such as an exchange button, a payout button, a help button, a bet button, and start button 23 or the like, are arranged on the operation table 16. An arrangement of these buttons is variable. Also, a part of the buttons can be omitted, and new button can be added and replaced, as needed. Also, a coin insertion slot 18 and a bill verifier 22 are arranged on the operation table 16.

Also, a coin payout opening 20 and a coin insertion portion 21 is formed on lower portion of the cabinet 12. The coin payout opening 20 is a portion where coins are paid out based on inputs of the exchange button or the payout button. And, the coin insertion portion 21 is a portion where the coins which are paid out from the coin payout portion 20 are received. A coin detection portion made up of sensor or the like is arranged inside the coin payout opening 20. The coin detection portion detects the number of coins which are paid out from the payout opening 20.

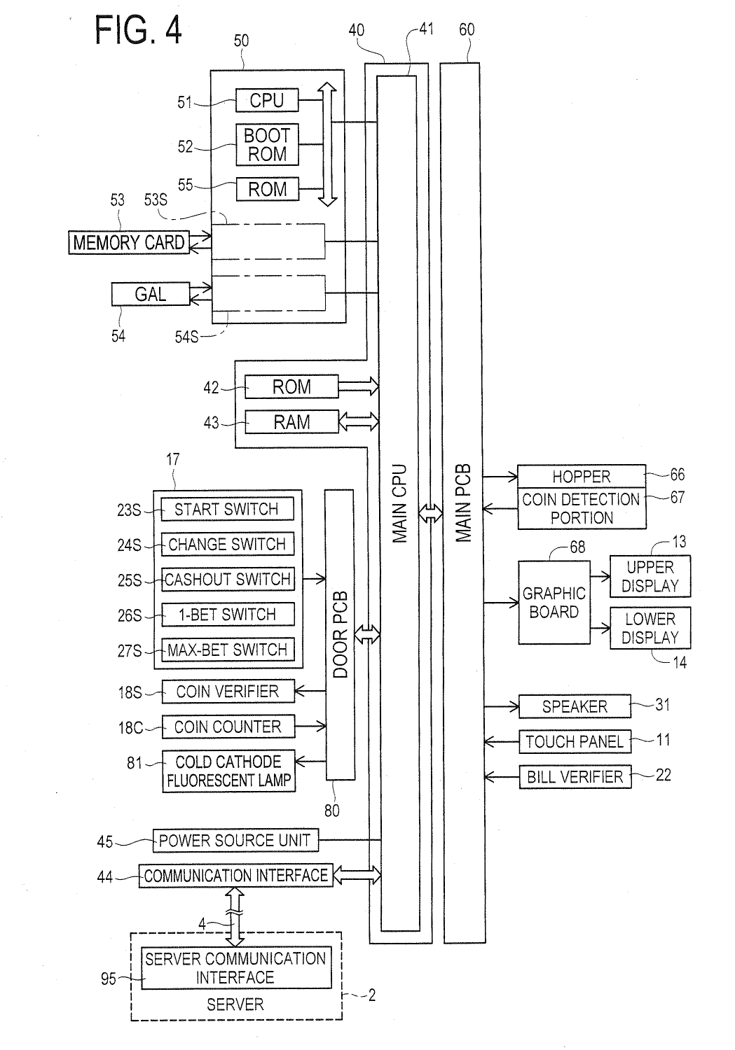

Next, a control system of the slot machine 1 of the embodiment will be described with reference of drawing. FIG. 4 is a block diagram of the control system of the slot machine 1 related to the embodiment.

As shown in FIG. 4, the control system of the slot machine 1 basically includes a mother board 40 and a gaming board 50.

The gaming board 50 includes a CPU 51, a ROM 55, a boot ROM 52, a card slot 53S, and an IC socket 54S which are interconnected via internal bus. A card slot 53S corresponds to the memory card 53. An IC socket 54S corresponds to a GAL (Generic Array Logic) 54.

The memory card 53 is constructed from non-volatile memory and is memory medium in which game programs and game system programs (hereinafter, “the game program and the like”) is stored. The card slot 53S is constructed so that the memory card 53 is detachable, and connected to the mother board 40 via IDE bus, for example. Accordingly, kinds of game and contents can be changed by updating the game program and the like stored in the memory card 53.

Also, the kinds of game and the contents can be changed by exchanging to a memory card 53 in which another game program and the like is stored.

Here, the game program includes image data and sound data or the like, as programs related to game session and image data, sound data, and notification data.

The GAL 54 is one of PLD which contains a fixed OR array construction. The GAL 54 has plural input ports and output ports, and if predetermined data is input to the input ports, the data corresponding thereto will output to the output ports. This output data from the output ports is the payout ratio setting data as described.

The IC socket 54S is constructed so that the GAL 54 is detachable, and connected to the mother board 40 via PCI bus. Accordingly, the payout ratio setting data output from the GAL 54 can be changed by updating the GAL 54 or exchanging the GAL 54 itself.

The CPU 51, the boor ROM, and the ROM 55, which are interconnected via an internal bus, are connected to the mother board 40 via PCI bus. The PCI bus performs signal transfer between the mother board 40 and the gaming board 50. And, it performs electricity supply from the mother board 40 to the gaming board 50. The country identification data and the verification program are stored in the ROM 55. The preliminary verification program and program for the CPU 51 to boot up the preliminary verification program (boot code) or the like are stored in the boot ROM 52.

The verification program is program to verify the game program and the like (falsification check program). The verification program is described according to procedure of falsification check for the game program or the like which is target of verification import process. The preliminary verification program is a program to verify above verification program and described according to procedure of falsification check for the verification program which is target of verification process.

Next, the mother board 40 will be described. The mother board 40 is constructed using commercially general mother board (printed circuit board which mounts basic components of personal computer) and includes the main CPU 41, the ROM 42, the RAM 43, and the communication inter face 44.

The ROM 42 is constructed from a memory device such as the flash memory and program or the like such as BIOS or the like executed in the main CPU 41 is stored. When the BIOS is executed by the CPU 41, initial process for predetermined peripheral device is executed and import process for game programs or the like stored in the memory card 53 is started via the gaming board 50.

Data and programs, which are used when the main CPU 41 runs, are stored in the RAM 43. Also, the verification program which is read via the gaming board 50, various programs such as the game program and the like, various information such as credit number which the player owns or the like can be stored in the RAM 43.

And, the communication interface 44 is a communication device to communicate to the server via the network 4. The slot machine 1 communicates with the server 2 via the communication interface 44.

And, a main PCB (Printed Circuit Board) 60 which will be described later and a door PCB 80 are connected to the mother board 40 respectively via USB. A power source unit 45 is connected to the mother board 40. If the power source unit 45 supplies the electric power to the mother board 40, the main CPU 41 on the mother board 40 will be booted up. Further, the electric power is supplied to the gaming board 50 via PCI bus, and the CPU 51 is booted up.

Equipment and device, which generate the input signal to the main CPU 41, and equipment and device, which operation is controlled by the control signal from the main CPU 41, are connected to the main PCB 60 and the door PCB 80. The main CPU 41 executes the game program and the like stored in the RAM 43 based on the input signal which is input to the main CPU 41. And, by executing predetermined calculation processes, processes for storing calculation result to the RAM 43 and control for each equipment and devices are executed.

A sub CPU 61, a hopper 66, a coin detection portion 67, a graphic board 68, a loudspeaker 31, a touch panel 15, and the bill verifier 22 is connected to the main PCB 60.

The touch panel 15 is arranged in front of the lower display 14, identifies a coordinate of a portion where the player touches, and can recognize where the player touches, further where the player moves based on the coordinate information of the portion touched by the player.

The hopper 66 is arranged inside the cabinet 12, and pays a predetermined number of coins from the coin payout opening 20 to the coin insertion portion 21 based on the control signal from the main CPU 41. A coin detection portion 67 is arranged inside the coin payout opening 20, and if the coin detection portion 67 that the coins with the predetermined number is paid out from the coin payout opening 20, the input signal is output to the main CPU 41.

The graphic board 68 controls the display image of the upper display and the lower display based on control signal from the main CPU 41.

And, the graphic board 68 controls the upper display 13 and the lower display 14 based on the control signal which is sent from the server 2 in cooperative image effects which will be described later.

Here, the graphic board 68 includes VDP (Video Display Processor) which generates image data based on the control signal and video RAM which temporally stores image data generated by VDP or the like. Image data which is used when image data is generated by VDP is included in the game program.

And, the bill verifier 22 verifies the bill and ticket with barcode, and receives qualified bill and ticket with barcode into the cabinet 12. If verified bill is received, the bill verifies 22 outputs input signal to the CPU 41 based on amount of the bill. And, the input signal is output to the main CPU 41 based on the number of coins stored on the verified ticket with barcode.

On the other hand, the operation button 17, the coin verifier ISS, the coin counter 21C, and a cold cathode fluorescent lamp 81 is connected to the door PCB 80. A start switch 23s corresponding to the start button 23, a change switch 24S corresponding to the change button 24, a cashout switch 25S corresponding to cashout button 25, a 1-bet switch 26S corresponding to the 1-bet button 26, and a max-bet switch 27S corresponding to the max-bet button 27 are arranged on the operation button 17. If the corresponding button is operated by the player, the input signal is output to the main CPU 41.

The coin counter 21C is arranged inside the coin insertion slot 18, and verifies the coins which are input to the coin insertion slot 18 by the player. Things other than verified coins are ejected to the coin payout opening 20, and if verified coins are detected, the input signal is output to the main CPU 41.

The coin verifier 18S performs based on the control signal output from the main CPU 41, and sorts the coins which are recognized as the verified coins by the coin counter 18C into a cash box (not shown) arranged inside the slot machine 1 or the hopper 66. A cold cathode fluorescent lamp 81 is arranged back side of the lower display 14 and the upper display 13, turns on based on the control signal from the main CPU 41, and functions as a back light.

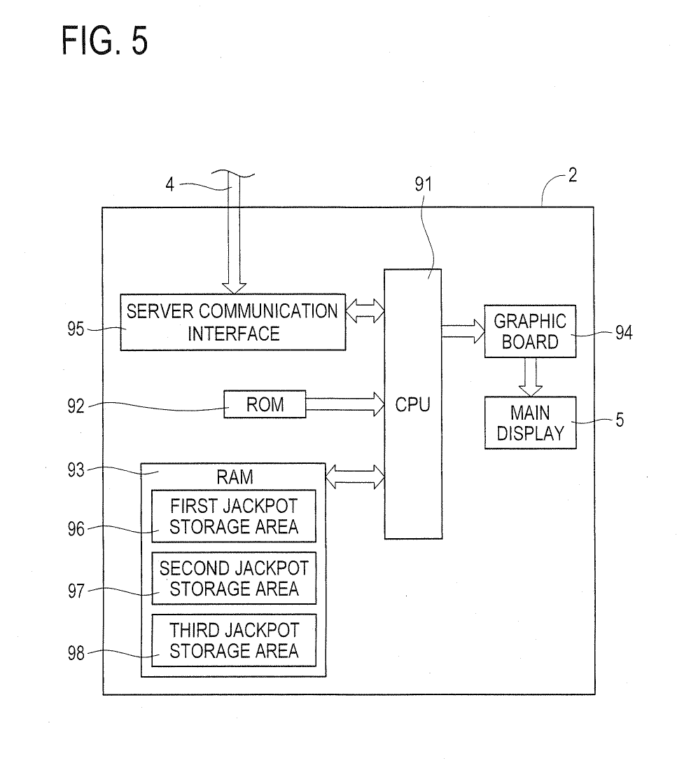

Next, a control system of the server 2 of the embodiment will be described with FIG. 5. FIG. 5 is a block diagram showing the control system of the server 2 according to the first embodiment.

As shown in FIG. 5, the control system of the server 2 includes a CPU 91, a ROM 92, a RAM 93, a graphic board 94, a sever communication interface 95 which are interconnected via internal bus.

The ROM 92 is made up of memory device such as flash memory. Various program and permanent data is stored.

Data and programs used when the CPU 91 runs in stored in the RAM 93. And, the first jackpot storage area 96, the second jackpot storage 97, and the third jackpot storage area 98 are stored in the RAM 93. Jackpot amount of “MEGA jackpot” is stored in the first jackpot storage area 96. Jackpot amount of “MAJOR jackpot” is stored in the second jackpot storage area 97. Jackpot amount of “MEGA jackpot” is stored in the third jackpot storage area 98.

If MEGA progressive bonus is won, credits corresponding to jackpot amount of MEGA jackpot will be provided. If MAJOR progressive bonus is won, credits corresponding to jackpot amount of MAJOR jackpot will be provided. If MINOR progressive bonus is won, credits corresponding to jackpot amount of MINOR jackpot will be provided.

If the CPU 91 receives the bet information from the slot machine 1, jackpot amounts stored in the jackpot storage area 96 to 98 are read, and re-stored after a predetermined portion (for example, 1%) of credits which are bet in the slot machine 1 is added.

The graphic board 94 controls image display on the main display based on the control signal. Concretely, it is controlled as to display fish which indirectly notify jackpot amount of “MEGA jackpot”, “MAJOR jackpot”, and “MINOR jackpot”, plural anglers, and boat on which the plural anglers ride (see FIG. 1).

The graphic board 94 includes VDP (Video Display Processor) which generates image data based on the control signal and video RAM which temporally stores image data generated by VDP or the like. Here, image data which is used when image data is generated by VDP is included in the ROM 92.

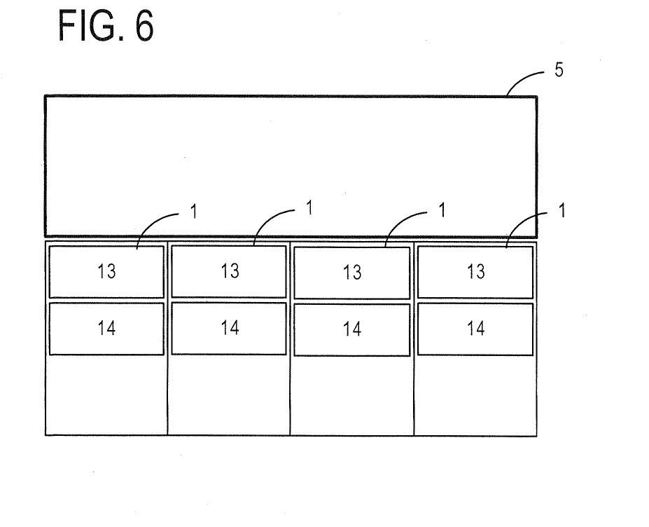

FIG. 6 shows a positional relationship between the plural slot machines 1 and the main display 5. As shown in FIG. 6, one main display 5 is arranged on top of the plural slot machines 1.

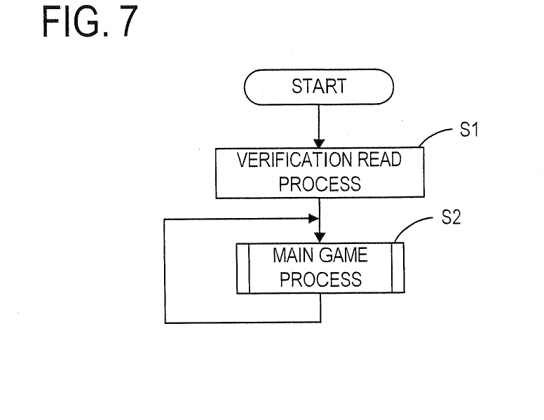

A main control program, which is executed in the slot machine 1 of the embodiment, will be described in detail with reference to the drawing. FIG. 7 is a flowchart of the main control program. Here, concerning the slot machine 1, the memory card 53 is already inserted to the card slot 53S of the gaming board 50, and the GAL 54 is installed to the IC socket 54S.

At first, when the input of the power switch (input of power source) is performed on the power source unit 45, the mother board 40 and the gaming board 50 are booted-up respectively, and the verification read process of S1 is executed. In the verification read process, the mother board 40 and the gaming board 50 execute separately processes in parallel.

In the gaming board 50, the CPU 51 reads the preliminary verification program from the boot ROM 52, and verifies and authenticates that the verification program is not falsified before the verification program is taken to the mother board 40.

On the other hand, in the mother board 40, the main CPU 41 executes BIOS stored in the ROM 42, expands compressed data embedded in BIOS on the RAM 43, executes BIOS expanded on the RAM 43, and performs diagnostic and initialization for various peripheral devices.

After that, the CPU 41 reads the verification program stored in the ROM 55, and certifies to verify and authenticate that the game programs or the like stored in the memory card 53 which is inserted to the card slot 53S. After the verification process is normally ended, the main CPU 41 writes programs or the like which are authentication target (which are authenticated) to the RAM 43, and acquires payout data and country ID.

After above processes is executed, the main CPU 41 finishes the verification read process.

After that, in S2, the main CPU 41 sequentially reads and executes the game program and the like which was verified in the verification real process of S1 from the RAM 43, and executes the main game process. The game according to the first embodiment of the slot machine 1 is executed by executing this main game process. And, the main game process is executed repeatedly during the electronic power source being supplied.

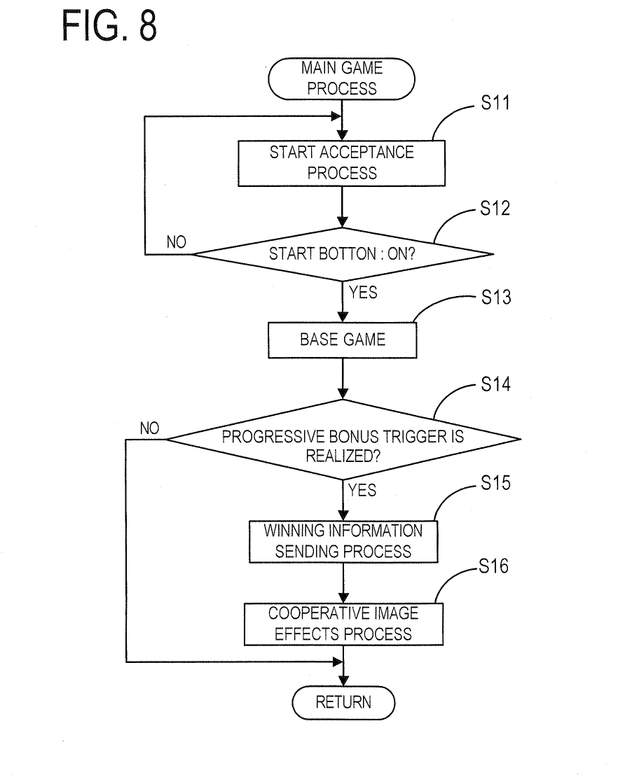

Next, the main game process executed in each of the slot machines 1 will be described with reference to drawing. FIG. 8 is a flowchart of the main game program. Program to execute the flowchart is stored in the ROM 42 and the RAM 43 embedded in the slot machine 1. And, it is executed in the main CPU 41.

In S11, a start acceptance process is executed. In the start acceptance process, after predetermined initial settings are performed, setting for bet count or the like are performed. And, insertions for coins are performed from the coin insertion slot 18 by the player. Also, bet operations using the operation button 17 is performed. The number of coins inserted from the coin insertion slot 18 and bet operation using the operation button 17 are detected.

In S12, it is determined whether or not the start button 23 is operated. It is determined whether or not the start button 23 is operated based on that whether or not the input signal from the start switch 23S is received or not.

If it is determined that the start button 23 is not operated (S12:NO), the procedure will be returned to the start acceptance process again. At this time, operations such as adjustment for bet count or the like is variable can be performed. On the other hand, if it is determined that the start button 23 is operated (S12:YES), the bet count which is set is subtract from credit count in which the player owns, and the bet count is stored in RAM 43 as the bet information. After that, the procedure is shifted to S13.

In S13, the base game is executed. In the base game, for example, after symbol rows are variably displayed in the symbol display portions 101 to 103, stopped and displayed. And, an award is provided based on a combination of stopped symbols. Known various games can be executed as the base game. Also, a predetermined award is provided based on a game result. After that, shifts to S14.

In S14, it is determined whether or not the progressive bonus trigger is realized. It can be determined whether or not the progressive bonus trigger is realized based on whether or not a combination of symbols which are stopped and displayed in S13 meets a predetermined condition. If any of MEGA progressive bonus, MAJOR progressive, or MINOR progressive bonus is won, the progressive bonus trigger is realized.

If it is determined that the progressive bonus is realized (S14:YES), the procedure is shifted to S15. On the other hand, if it is determined that the progressive bonus is not realized (S14:NO), the main game process is finished.

In S15, a winning information sending process is executed. In the winning information sending process, above winning information is sent to the server 2. After that, the procedure is shifted to S16.

In S16, a cooperative image effects process is performed. Details of the cooperative image effects process will be described later.

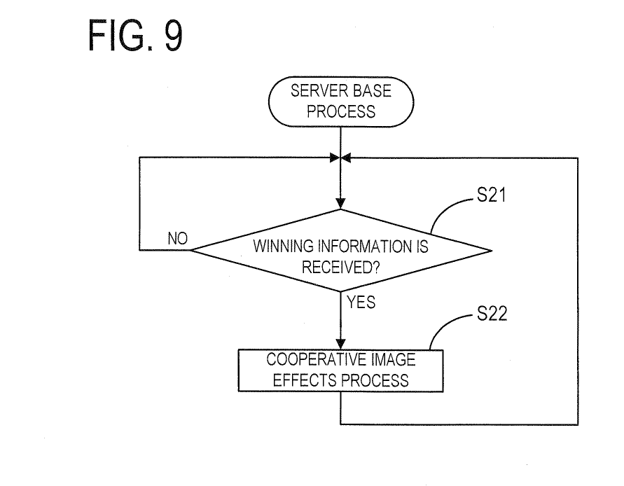

Next, a server base process executed by the server 2 will be described. FIG. 9 is a flowchart of the serve base process. A program to execute the flowchart of FIG. 9 is stored in the ROM 92 and the RAM 93 embedded in the server 2. And, it is executed by the CPU 91.

In S21, the winning information is received from any of the connected slot machines 1. If it is determined the winning information is not received (S21:NO), the process waits in S21.

If it is determined that the winning information is received (S21:YES), the procedure will be shifted to S22. At this time, the slot machine 1 winning the progressive bonus can be identified based on the received winning information. In S22, the cooperative image effects process is executed.

The cooperative image effects process executed in S16 of FIG. 8 and S22 of FIG. 9 will be described in detail. This process can be implemented by slot machine 1 and the server 2 performing inter-process communication. The process is mainly executed in the CPU 91 embedded in the server 2. Concretely, the CPU 91 control image effects of the main display 5, the upper display 13, and the lower display 14 by sending predetermined control signals to the graphic board 94 and the graphic board 68.

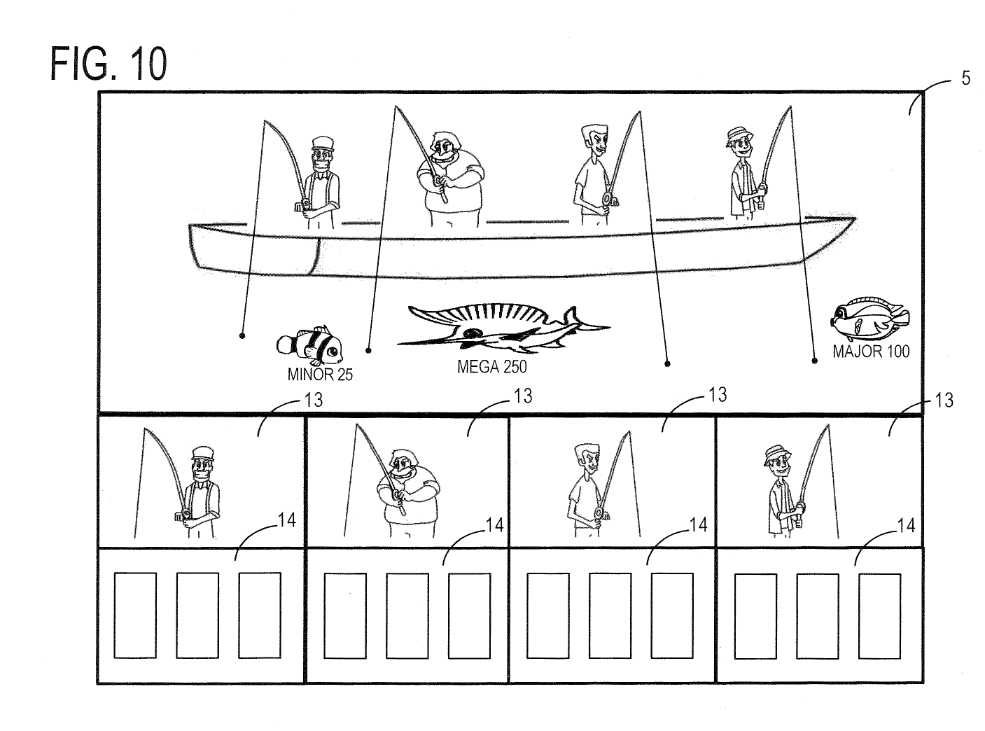

FIG. 10 is an example of image displays of the main display 5 and the upper display 13 and the lower display 14 of the slot machine 1 in the base game. As shown in FIG. 10, the angler is displayed on the upper display of each of the slot machines 1. Also, symbol display portions are displayed on the lower display 14. Also, plural anglers, fish, and boat are displayed on the main display 5.

Fish displayed on the main display 5 are three different types. Also, around each of fish, jackpot names corresponding thereof and jackpot amount are displayed.

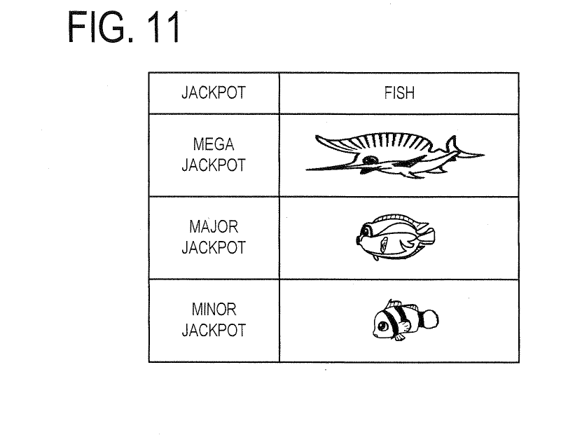

FIG. 11 shows a correspondence relation ship between the jackpots and the fish. Sizes of fish to be displayed on the main display 5 can be changed based on the corresponding jackpot amount.

And, the angler is displayed on the upper display 13 of each of the slot machine 1. The angler to be displayed on the upper display 13 corresponds to the angler to be displayed on the main display 5.

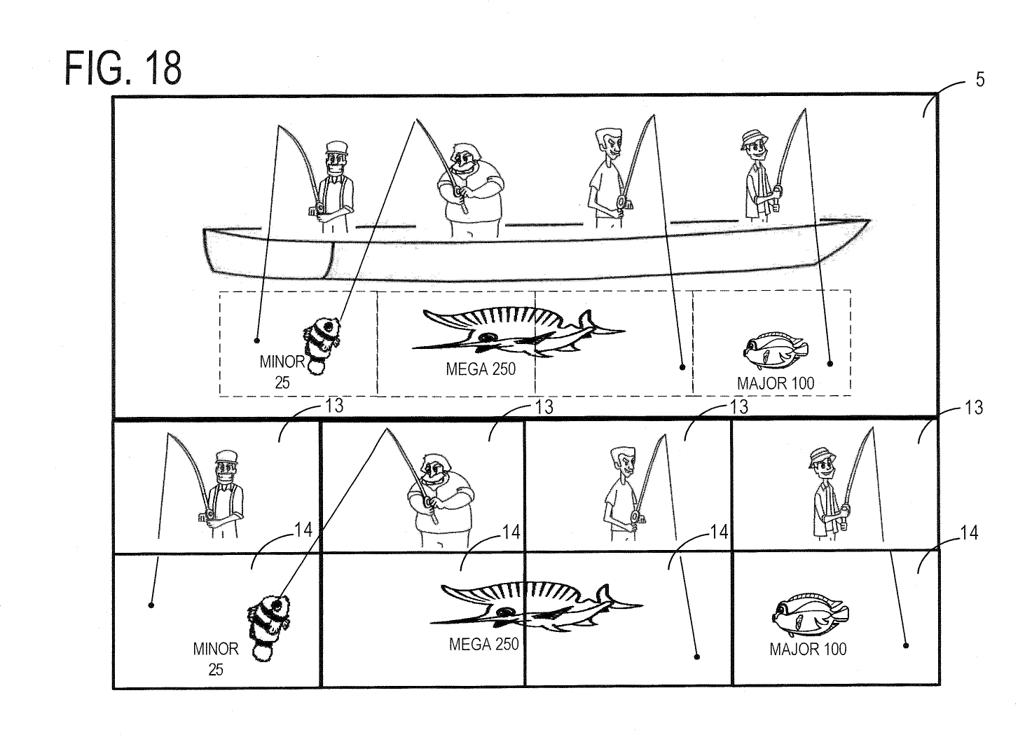

Image effects when the left most slot machine 1 shown in FIG. 10 (hereinafter “slot machine A”) wins the MINOR progressive bonus will be described below. In this case, in S15 of FIG. 18, the slot machine A sends winning information which indicates that the slot machine A wins MINOR progressive bonus to the server 2. If the sever 2 receives this winning information in S22 of FIG. 9, sends information which indicates that the cooperative image effects process will be executed to the slot machine A.

Herewith, as shown in FIG. 1, image of the lower display 14 of the slot machine A is switched. Concretely, image contents, which are displayed on a part of the main display 5 (shown with dotted line), are displayed on the lower display 14 of the slot machine A. Herewith, image contents of lower display 14 cooperates with the image contents of the part of the main display 5.

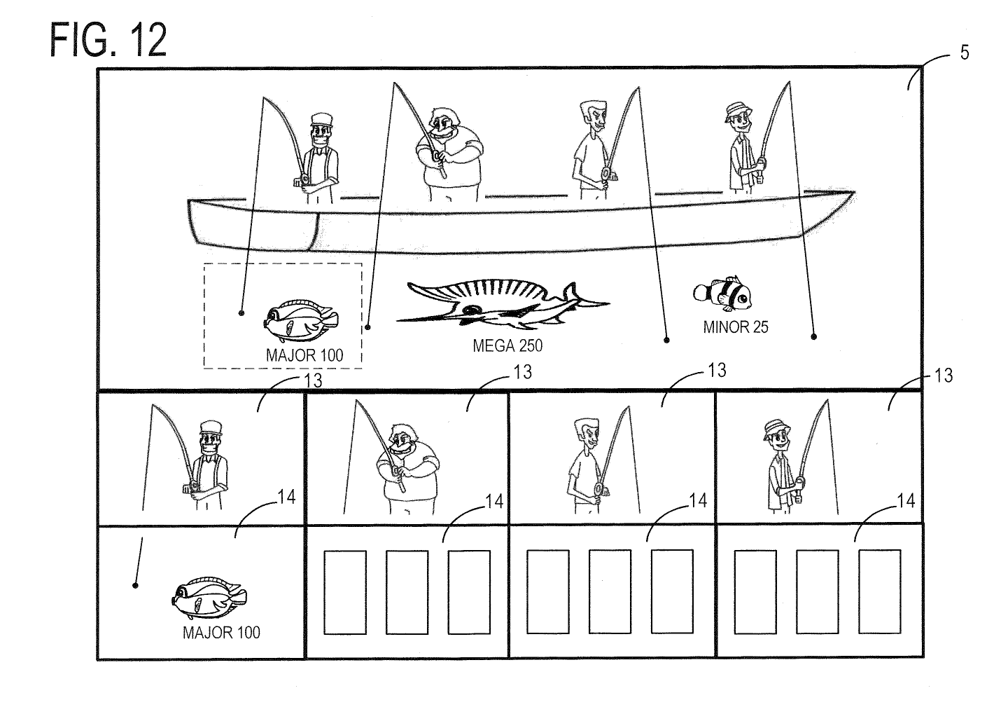

Consequently, as shown in FIG. 12, if the fish on the main display 5 moves, image contents of the lower display 14 of the slot machine A will be changed based on that.

And, at this time, the player using the slot machine A can not discriminate which progressive bonus is won among three progressive bonuses.

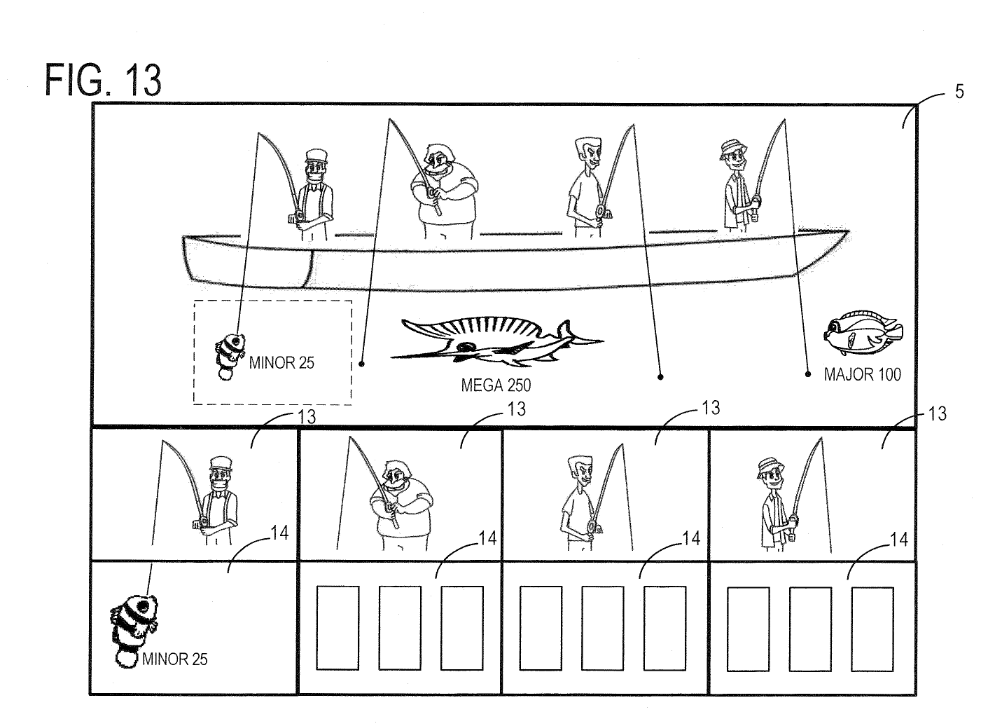

After that, image effects, which the fish corresponding to the progressive bonus which is won eats bait in which the angler corresponding to the slot machine A has, is made on the lower display 14 of the slot machine A (see FIG. 13).

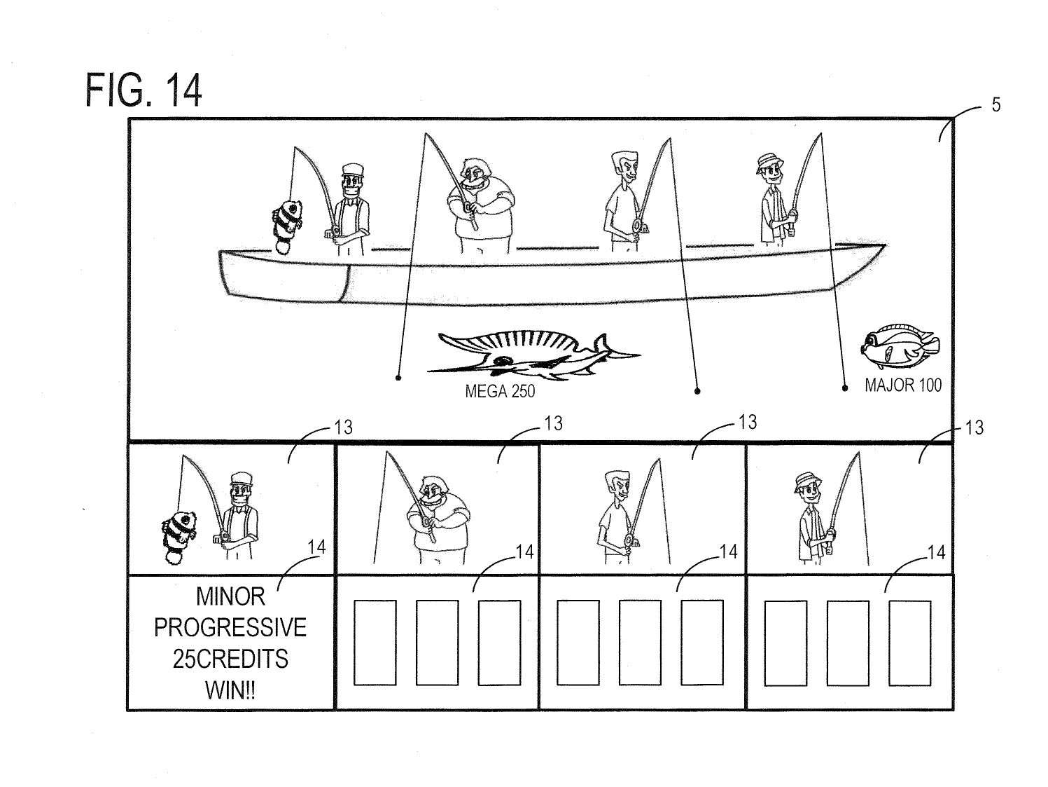

After that, image effects in which the fish is pulled in are made on the upper display 13 of the slot machine A (see FIG. 14). Also, information, which indicates that progressive bonus is won, is displayed on the lower display 14 of the slot machine A (see FIG. 14). In FIG. 14, the lower display 14 of the slot machine A notifies that MINOR progressive bonus is won and jackpot amount of MINOR jackpot is 25 credits.

At this time, since the image effects, in which the angler displayed on the upper display 13 of the slot machine A pulls in the fish, are made on the main display 5, other players and onlookers can be notified of that the player of the slot machine A wins the progressive bonus.

And, the jackpot amount of MINOR jackpot (25 credits) is provided in the slot machine A. Also, the jackpot amount of jackpot corresponding to the won progressive bonus is set to initial value.

After the jackpot amount is provided, images of upper display 13 and the lower display 14 of the slot machine A is changed to the image display of the base game (see FIG. 10).

As mentioned above, in the first embodiment, since the cooperative image effects are made on the upper display 13 and the lower display 14 of the slot machine 1 which the progressive bonus is won, and the main display 5, new entertainment aspect can be provided. Also, since process to cooperate image effects is mainly executed in the CPU 91 of the server 2, that process load of each slot machine 1 is increased can be prevented

### Second Embodiment

Next, a second embodiment of the present invention will be described. Since a main control program executed in the slot machine 1 is the same as the main control program of the first embodiment, explanation thereof will be omitted.

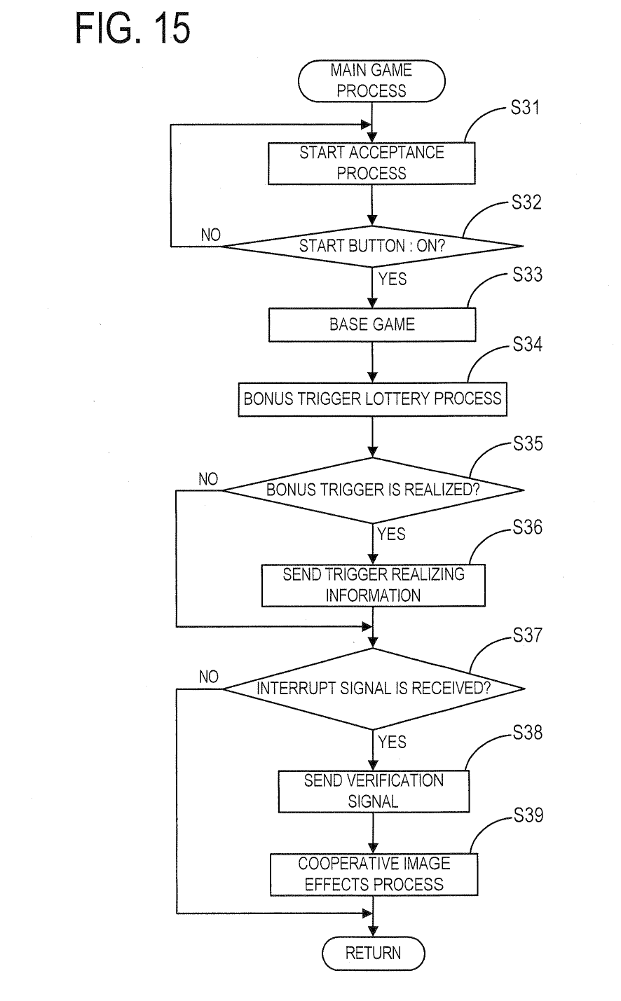

A main game process of the second embodiment will be described with reference drawing in detail. FIG. 15 shows a flowchart of the main game process. Since processes of S31 to S33 are the same as the processes of S11 to S13 of FIG. 8 as described, explanation thereof will be omitted.

In S34, a bonus trigger lottery process is executed. It is determined whether or not the bonus trigger is realized by lottery. At this time, a probability of that the bonus trigger is realized can be set arbitrarily. Also, it can be variable based on the payout ratio or the bet amount. Here, it can be constructed that the bonus trigger lottery process is executed at a predetermined timing.

In S35, it is determined whether or not the bonus trigger is realized. If it is determined that the bonus trigger is realized (S35:YES), the procedure will be shifted to S36. If it is determined that the bonus trigger is not realized (S35:NO), the procedure will be shifted to S37.

In S36, the trigger realizing information which indicates that the bonus trigger is realized is sent to the sever 2. At this time, the identification signal which identifies the slot machine 1 in which the bonus trigger is realized can be included.

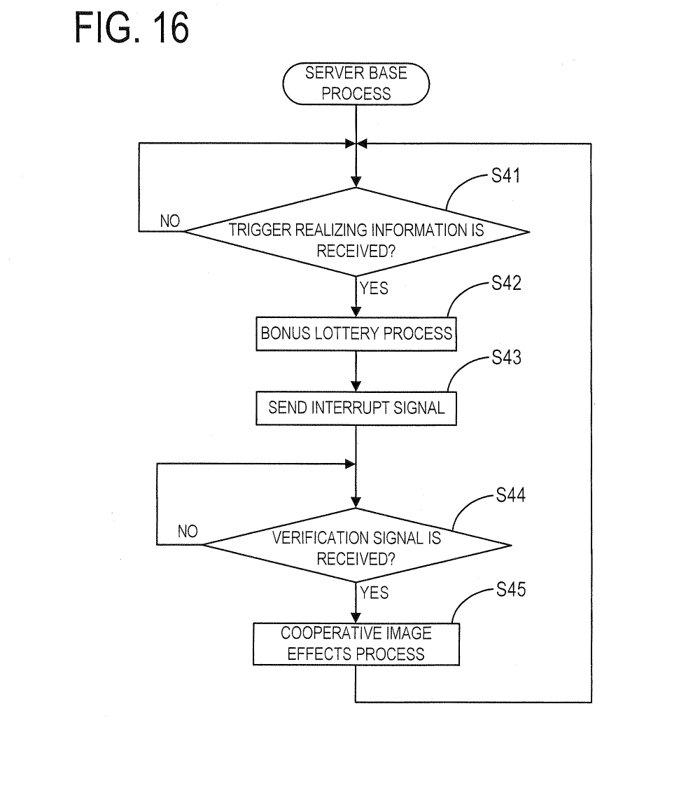

In S37, it is determined whether or not the interrupt signal from the server 2 is received. In the flowchart shown in FIG. 16, this process is executed after S36, however, executing timing of this process is can be set arbitrarily.

If it is determined that the interrupt signal is received (S37:YES), the procedure will be shifted to S38. If it is determined that the interrupt signal is not received (S37:NO), the main game process will be finished.

In S38, a verification signal which indicates that the interrupt signal is received is sent to the server 2. After that, the procedure will be shifted to S39. Implementation of the cooperative image effects process of S39 is started based on the process start signal from the server 2. Details of the cooperative image effects process will be described later.

Next, the server base process executed in the server 2 will be described with reference to drawing in detail. FIG. 16 is a flowchart of the server base process. In S41, it is determined whether or not the trigger realizing information is received from any of the slot machines 1. If it is determined that the trigger realizing information is not received (S41:NO), the process waits in S41. On the other hand, if it is determined that the trigger realizing information is received (S41:YES), the procedure will be shifted to S42.

In S42, the bonus lottery process is executed. In the bonus lottery process, it is determined by lottery which slot machine 1 wins the progressive bonus among the slot machines 1 which are connected to the server 2. Also, it is determined by lottery which progressive bonus is won among three progressive bonuses.

At this time, winning probability of the progressive bonus for each slot machine 1 can be set with equally. At this time, in the example shown in FIG. 10 (namely, four slot machines 1 are connected), each of the winning probability of the progressive bonus of each slot machine 1 is 25%. Also, the winning probability of the progressive bonus of slot machine 1 which the bonus trigger is realized can be set higher. At this time, the winning probability can be set arbitrarily. After the bonus lottery process is finished, the procedure is shifted to S43.

In S43, an interrupt signal which indicates that the cooperative image effects process is executed. At this time, above winning notification information is also sent to the slot machine 1 which the progressive bonus is won. After that, the procedure will be shifted to S44.

In S44, it is determined whether or not verification signal from the slot machine 1 to which the interrupt signal send is received. If it is determined that the verification signals from all of the slot machines 1 (S44:YES), the procedure will be shifted to S45. On the other hand, if it is determined that the verification signal is not received from at least one slot machine (S44:NO), the process waits until the verification signals are received from all of the slot machines 1.

In S45, a process start signal which indicates to start the cooperative image effects process is sent. After that, the cooperative image effects process is started.

Next, the cooperative image effects process executed in S39 of FIG. 15 and S45 of FIG. 16 will be described later. This process is mainly executed in the CPU 91 embedded in the server 2. Concretely, the CPU 91 controls image effects of the main display 5, the upper display 13, the lower display 14 by sending predetermined control signals to the graphic board 94 and the graphic board 68. To control image effects of upper displays 13 and the lower displays 14 of each of the slot machines 1, the graphic board 68 controls display images based on the control signal which sent from the CPU 91.

Since image displays in the base games are same as the image displays shown in FIG. 10, explanation thereof will be omitted.

Image effects when the bonus trigger of the slot machine A shown in FIG. 10 is realized and a second slot machine 1 from the left (hereinafter, “slot machine B”) wins MINOR progressive bonus will be described below.

In this case, in S36 of FIG. 15, the slot machine A sends the trigger realizing information which indicates the bonus trigger is realized to the server 2. The server 2 determines that the trigger realizing information is received in S41 of FIG. 16 and the procedure will be shifted to the bonus lottery process of S42. In S42, it is determined that the slot machine B wins MINOR progressive bonus. After predetermined process is executed, the cooperative image effects process is started.

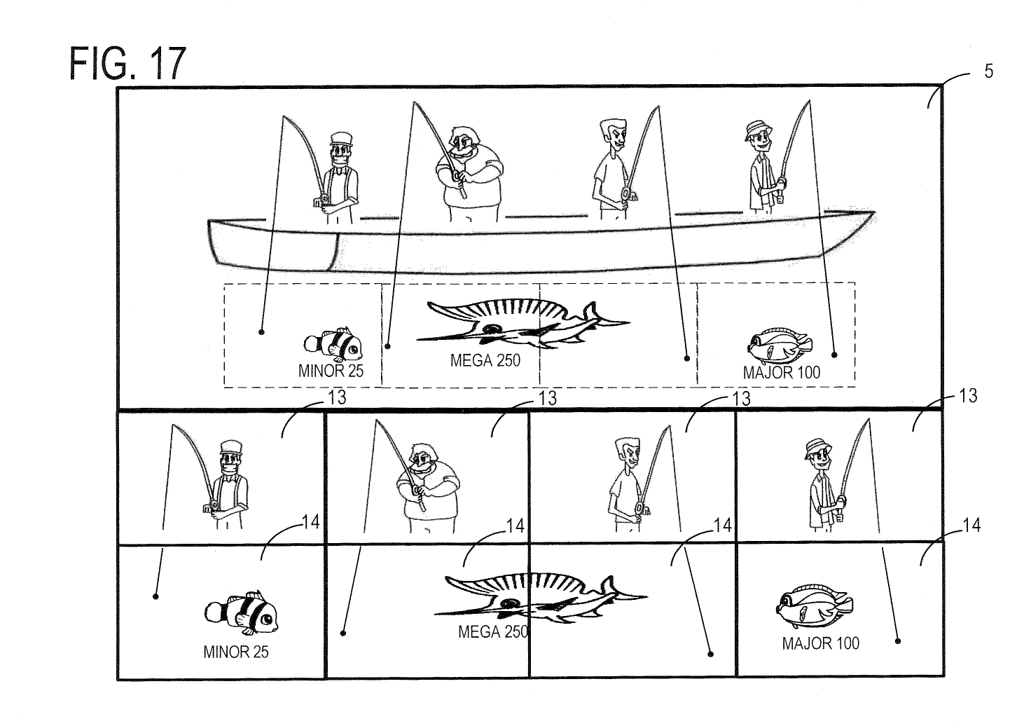

Herewith, as shown in FIG. 17, image of the lower display 14 of each slot machine 1 is switched. Concretely, image contents, which are displayed on a part of the main display 5 (shown with dotted line), are displayed on the lower display 14 of the slot machine 1. Herewith, image contents of lower display 14 cooperates with the image contents of the part of the main display 5.

And, at this time, each of the players can not discriminate which slot machine wins the progressive bonus and which progressive bonus is won.

After that, image effects, which the fish corresponding to MINOR progressive bonus displayed on the lower display 14 of the slot machine A eats bait in which the angler of the upper display 13 of the slot machine B has, is made on the lower display 14 of the slot machine A (see FIG. 18).

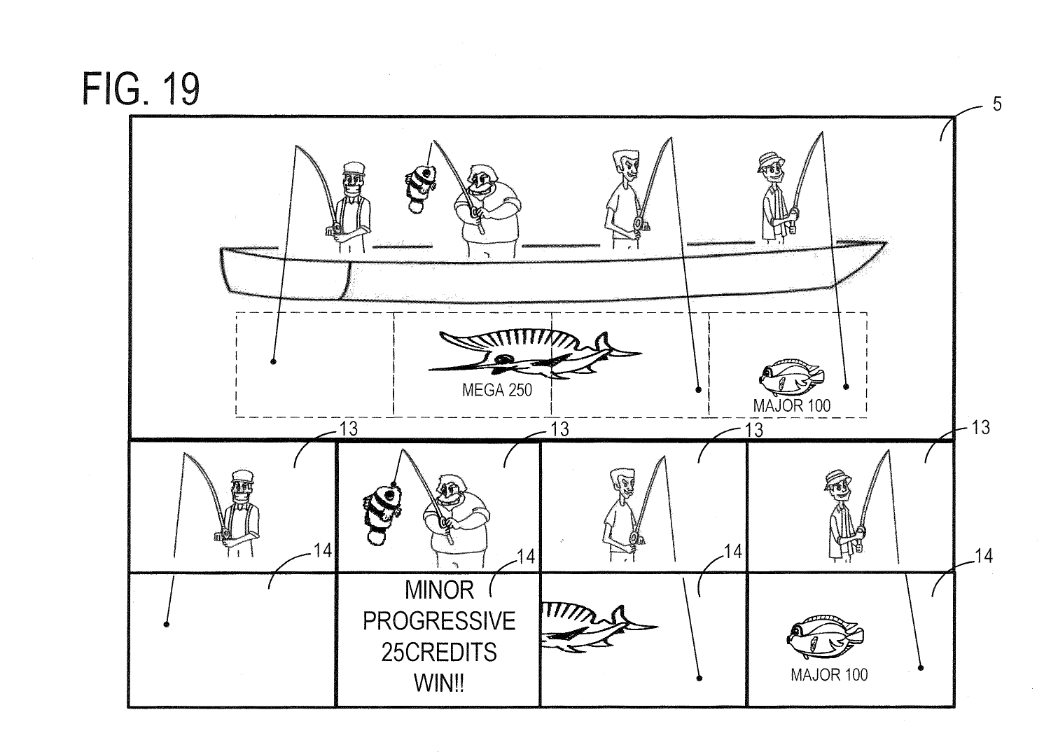

After that, image effects in which the fish is pulled in are made on the upper display 13 of the slot machine B (see FIG. 19). Also, information. which indicates that progressive bonus is won, is displayed on the upper display 14 of the slot machine B (see FIG. 19). In FIG. 19, the lower display 14 of the slot machine B notifies hat MINOR progressive bonus is won and jackpot amount of MINOR jackpot is 25 credits.

At this time, since the image effects, in which the angler displayed on the upper display 13 of the slot machine B pulls in the fish, are made on the main display 5, other players and onlookers can be notified of that the player of the slot machine B wins the progressive bonus.

And, the jackpot amount of MINOR jackpot (25 credits) is provided in the slot machine B based on received winning notification signal. Also, the jackpot amount of jackpot corresponding to the won progressive bonus is set to initial value.

After the jackpot amount is provided, images of upper display 13 and the lower display 14 of each slot machine 1 is changed to the image display of the base game (see FIG. 10).

As mentioned above, in the second embodiment, the slot machine in which the bonus trigger is realized can differ from the slot machine winning the progressive bonus. And, the bonus trigger occurs at random. Since the cooperative image effects process related to the progressive bonus occurs at random, new entertainment aspect can be provided. Also, since process to cooperate image effects is mainly executed in the CPU 91 of the server 2, that process load of each slot machine 1 is increased can be prevented

### Third Embodiment

In the above second embodiment, each of the slot machines 1 determines by lottery whether or not the bonus trigger is realized. Also, it is determined which slot machine 1 wins the progressive bonus and which progressive bonus is won by lottery in the server 2. However, the present invention is not limited to this embodiment.

The third embodiment of the present invention is described below. Since a main control program executed in the slot machine 1 is the same as the main control program of the second embodiment, explanation thereof will be omitted.

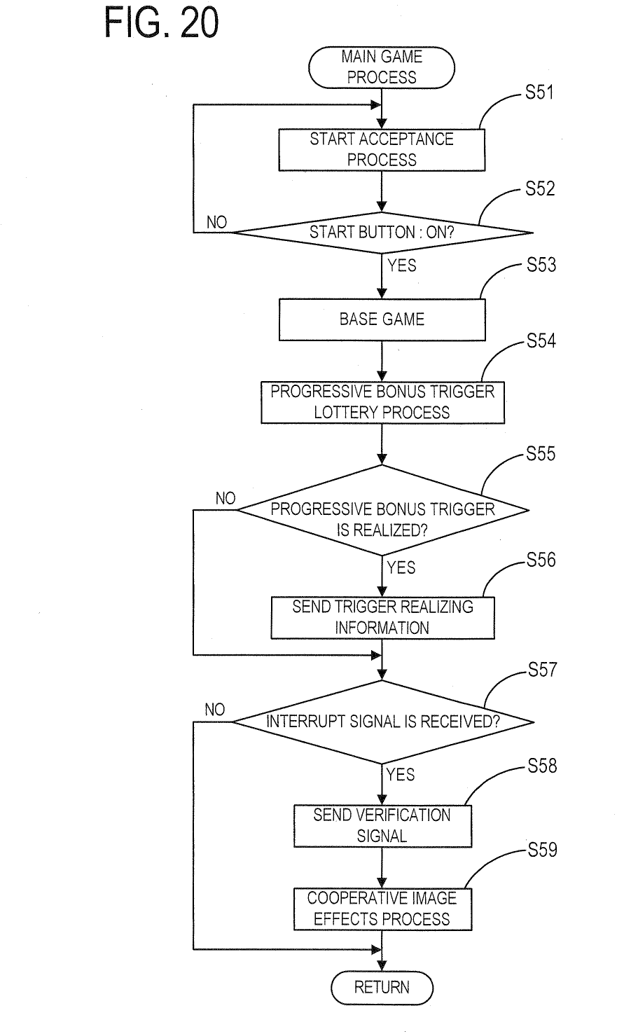

A main game process in the third embodiment will be described with reference to drawings. FIG. 20 is a flowchart of the main game process of the third embodiment. Since processes of S51 to S53 and S57 to S59 are the same as the processes of S31 to S33 and S37 to S39 of FIG. 15 in the second embodiment as described, explanation thereof will be omitted.

In S54, a progressive bonus trigger lottery process is executed. It is determined whether or not the progressive bonus trigger is realized based on lottery. At this time, a probability of that the progressive bonus is realized can be set arbitrarily. Also, it can be variable based on the payout ratio or the bet amount. Here, it can be constructed that the progressive bonus trigger lottery process is executed at a predetermined timing.

Also, if the progressive bonus is realized, it is determined by lottery which progressive bonus is won. At this time, it is determined by lottery which progressive bonus is won among three progressive bonuses (MEGA progressive bonus, MAJOR progressive bonus, or MINOR progressive bonus). After that, the procedure will be shifted to S55.

In S55, it is determined whether or not the progressive bonus trigger is realized. If it is determined that the progressive bonus trigger is realized (S55:YES), the procedure will be shifted to S56. If it is determined that the progressive bonus is not realized (S55:NO), the procedure will be shifted to S57.

In S56, the trigger winning information which indicates that the progressive bonus trigger is realized is sent to the serve 2. At this time, the trigger winning information includes identification signal to identify the slot machine 1 in which the progressive bonus trigger is realized and identification signal to identify which progressive bonus is won. Accordingly, the server 2 which will be described later does not execute the bonus lottery process (S42) of FIG. 16 in the second embodiment. That is, in the third embodiment, a part of the processes executed in the server 2 in the second embodiment is executed in the slot machine 1.

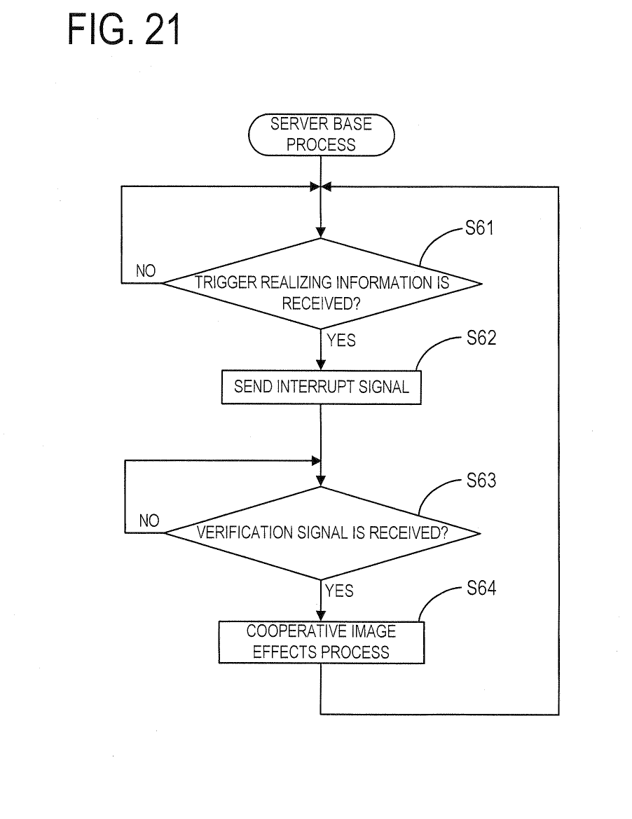

Next, the server base process of the third embodiment will be described with reference to drawing in detail. FIG. 21 is a flowchart of the server base process of the third embodiment. Since processes of S61, S63, and S64 are basically same as the processes of S41, S44, and S45 of FIG. 16 of the second embodiment as described respectively, explanation thereof will be omitted.

Also, in the third embodiment, the trigger realizing information which is received includes identification signal to identify the slot machine 1 in which the progressive bonus trigger is realized and identification signal to identify which progressive bonus is won. And, based on the received identification signals, it can be identified which slot machine 1 wins which progressive bonus. As a result, the bonus lottery process (S42 of FIG. 16) in the second embodiment as described is not executed.

And, in S62, an interrupt signal, which indicates that the cooperative image effects process is executed, is sent to the connected slot machines 1. Here, information indicating jackpot amount of the jackpot corresponding to the won progressive bonus is sent to the slot machine 1 in which the progressive bonus is won.

Next, the cooperative image effects process executed in S59 of FIG. 20 and S64 of FIG. 21 will be described in detail. This process is mainly executed in the CPU 91 embedded in the server 2. Since the processes in the CPU 91 are the same as above second embodiment basically, explanation thereof will be omitted.

And, since image displays in the base game are the same as the image display shown in FIG. 10, explanation thereof will be omitted.

Image effects when the progressive bonus trigger of the slot machine A shown in FIG. 10 is realized and MINOR progressive bonus is won will be described below.

In this case, in S56 of FIG. 20, the slot machine A sends the trigger realizing information which indicates the progressive bonus trigger is realized to the server 2. The server 2 determines that the trigger realizing information is received in S61 of FIG. 21. Also, since the trigger realizing information includes identification information indicating which progressive bonus is won, the progressive bonus which is won can be identified by using the identification information. After a predetermined process is executed, the cooperative image effect process will be started.

Herewith, as shown in FIG. 17, image of the lower display 14 of each slot machine 1 is switched. Concretely, image contents, which are displayed on a part of the main display 5 (shown with dotted line), are displayed on the lower display 14 of each of the slot machine 1. Herewith, image contents of lower display 14 cooperates with the image contents of the part of the main display 5.

And, at this time, each of the players can not discriminate which slot machine wins the progressive bonus and which progressive bonus is won.

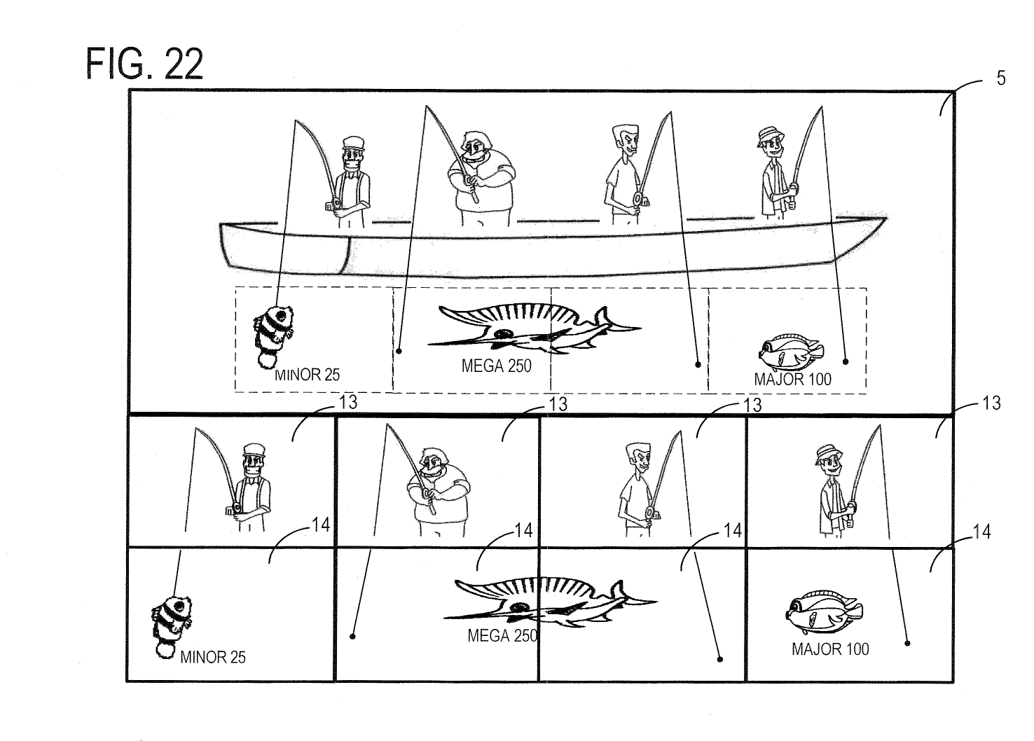

After that, image effects, which the fish corresponding to MINOR progressive bonus displayed on the lower display 14 of the slot machine A eats bait in which the angler of the upper display 13 of the slot machine A has, is made on the lower display 14 of the slot machine A (see FIG. 22).

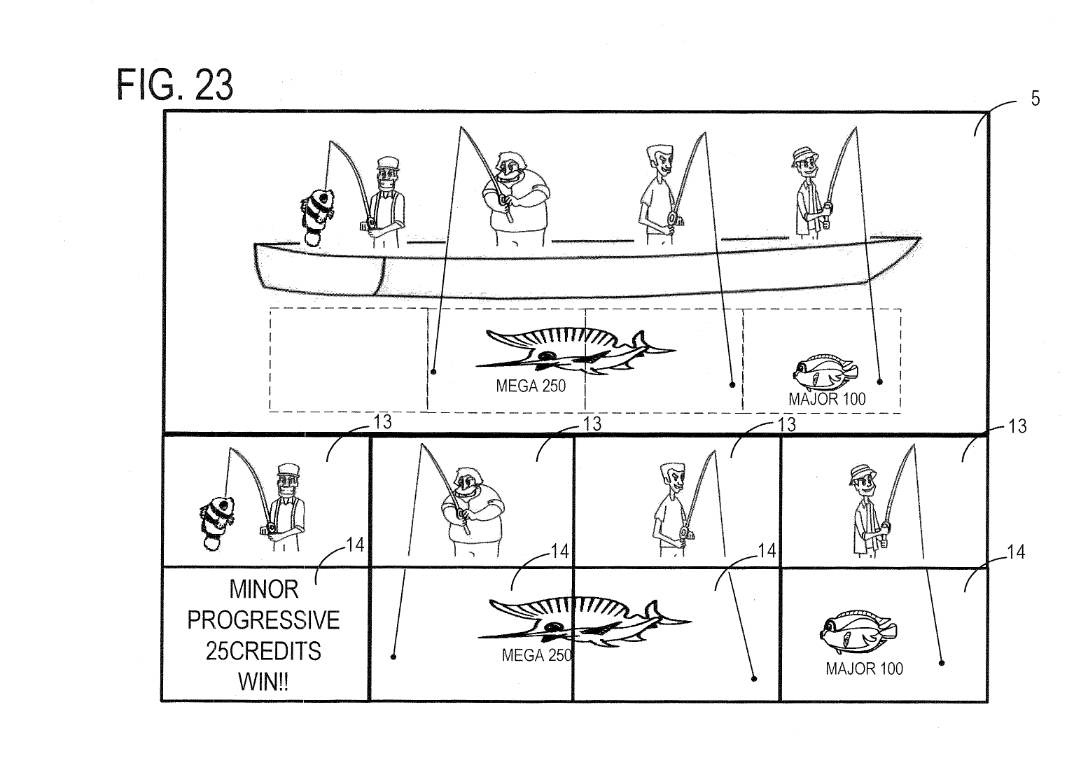

After that, image effects in which the fish is pulled in are made on the upper display 13 of the slot machine A (see FIG. 23). Also, information. which indicates that progressive bonus is won, is displayed on the lower display 14 of the slot machine A (see FIG. 23). In FIG. 23, the lower display 14 of the slot machine A notifies that MINOR progressive bonus is won and jackpot amount of MINOR jackpot is 25 credits.

At this time, since the image effects in which the angler displayed on the upper display 13 of the slot machine A pulls in the fish on the main display 5, other players and onlookers can be notified of that the player of the slot machine A wins the progressive bonus.

And, the jackpot amount of MINOR jackpot (25 credits) is provided in the slot machine A. Also, the jackpot amount of jackpot corresponding to the won progressive bonus is set to initial value.

After the jackpot amount is provided, images of upper display 13 and the lower display 14 of each of the slot machine is changed to the image display of the base game (see FIG. 10).

As mentioned above, in the third embodiment, if the slot machine 1 wins the progressive bonus, the image effects related to this winning is performed with cooperative on the displays of won slot machine 1, connected other slot machines 1, and the main display 5. And, the progressive bonus trigger occurs at random. Herewith, since the cooperative image effects process according to the progressive bonus occurs at random, new entertainment aspect can be provided.

The present invention is not limited to above embodiments and various changes and modifications can be done within the scope of the present invention certainly.

Also, the present invention is applied to card game machines. In this case, for example, in card game machine performing poker game or the like, if a predetermined condition is met, it can be constructed that the cooperative image effects process is executed.

Also, the present invention can be implemented as a playing method to execute above processes. Further, the present invention can be implemented as a program to execute above processes in one or more computers, and a tangible medium in which the program is stored.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A game system comprising:
plural gaming machines;
a common display; and
a processor; wherein
each of the plural gaming machines has a display, and
the processor makes image effects on the display of a predetermined gaming machine and image effects on the common display cooperate.

2. A game system comprising:
plural gaming machines;
a common display; and
a processor; wherein
the processor
(a) identifies the gaming machine meeting a predetermined condition among the plural gaming machines, and
(b) makes image effects on the display of the identified gaming machine and image effects on the common display cooperate.

3. The game system according to claim 2, wherein the predetermined condition is a winning of a progressive bonus.

4. The game system according to claim 3, wherein an image corresponding to jackpot amount of the won progressive bonus is displayed on the display of the identified gaming machine.

5. A game system comprising:
plural gaming machines;
a common display; and
a processor; wherein
each of the plural gaming machines includes a display and a controller,
the controller
(a) receives a start of a unit game,
(b) variably displays the plural symbols in response to receiving start of the unit game,
(c) displays the plural symbols on the display as a game result of the unit game, and
(d) determines whether or not a predetermined condition is met based on symbols displayed on the display,
wherein the processor
(e) identifies the gaming machine meeting a predetermined condition among the plural gaming machines, and
(f) makes image effects on the display of the identified gaming machine and image effects on the common display cooperate.

6. The game system according to claim 5, wherein the predetermined condition is a winning of a progressive bonus.

7. The game system according to claim 6, wherein an image corresponding to jackpot amount of the won progressive bonus is displayed on the display of the identified gaming machine.

8. A game system comprising:
plural gaming machines;
a common display; and
a processor; wherein
each of the plural gaming machines includes a display and a controller, the display displays plural video reels and plural symbols displayed on the video reels,
the controller
(a) receives a start of a unit game,
(b) performs spinning and stopping of the plural video reels in response to receiving start of the unit game,
(c) displays the plural symbols on the display as a game result of the unit game, and
(d) determines whether or not a predetermined condition is met based on symbols displayed on the display, and
the processor
(e) identifies the gaming machine meeting a predetermined condition among the plural gaming machines, and
(f) makes image effects on the display of the identified gaming machine and image effects on the common display cooperate.

9. The game system according to claim 8, wherein the predetermined condition is a winning of a progressive bonus.

10. The game system according to claim 9, wherein an image corresponding to jackpot amount of the won progressive bonus is displayed on the display of the identified gaming machine.
